(19) United States
(12) Patent Application Publication
(10) Pub. No.: US 2026/0197565 A1
(43) Pub. Date: Jul. 9, 2026

(54) Optical Switch

(71) Applicant: NTT, Inc., Tokyo (JP)

(72) Inventors: Osamu Moriwaki, Bunkyo-ku, Tokyo (JP); Kenya Suzuki, Bunkyo-ku, Tokyo (JP)

(21) Appl. No.: 18/867,992

(22) PCT Filed: Jun. 1, 2022
(86) PCT No.: PCT/JP2022/022398

§ 371 Date: Nov. 21, 2024

(51) Int. Cl. H04Q 11/00

(52) U.S. Cl. CPC H04Q 11/0003

(57) ABSTRACT

An optical switch according to the present disclosure includes: at least one switch function unit in which a plurality of one-input/two-output optical switches is connected in cascade; an optical coupler function unit in which a plurality of two-input/one-output optical couplers to which an optical signal output from the switch function unit is input is connected in cascade; and at least one of a first monitoring output port and a second monitoring output port, wherein the first monitoring output port is a port that transmits a first monitoring optical signal output from the switch function unit to an outside, and the second monitoring output port is a port that transmits, to an outside, a second monitoring optical signal output from a two-input/two-output optical coupler provided in place of a two-input/one-output optical coupler located at an end on an output side among the plurality of two-input/one-output optical couplers.

### TECHNICAL FIELD

The present disclosure relates to an optical switch.

### BACKGROUND ART

With the spread of the Internet, the demand for data communication networks is rapidly increasing. In order to cope with such a rapidly increasing demand, optical communication networks capable of transmitting a large amount of data with low power consumption have been widely constructed.

In an optical communication network, in addition to a function of directly connecting two points, optical switches are used, so that flexible routing is implemented. Among these optical switches, a multicast switch that controls a multiplexing/demultiplexing function in a colorless, directionless, contentionless-reconfigurable optical add drop multiplexer (CDC-ROADM) can be cited as an exemplary switch device widely used in recent years (see, for example, Non Patent Literature 1).

FIG. 1 is a diagram conceptually illustrating a configuration of a multicast switch 10 according to a conventional technique. The multicast switch 10 according to the conventional technique includes N (here, as an example, N=3) one-input/three(=M)-output optical switches 121 to 123 in each of which M (here, as an example, M=3) one-input/two-output optical switches 111a to 111c, 112a to 112c, or 113a to 113c are connected in cascade, M N-input/one-output optical couplers 141 to 143 in each of which N-1 two-input/one-output optical couplers 131a to 131b, 132a to 132b, or 133a to 133b, in which the merging ratio is 1:1, 1:2, . . . , and 1:(N-1), are connected in cascade, three (=N) input ports 151 to 153, and three (=M) output ports 161 to 163. Note that, here, M and N are integers of 2 or more. In addition, in FIG. 1, paths of optical signals are indicated by arrows.

In the optical switches 121 to 123, one of the outputs of each of the optical switches 111a to 111b, 112a to 112b, and 113a to 113b is connected to the input of an adjacent optical switch on the output side (for example, one of the outputs of 111a is connected to the input of 111b). However, the optical switches (111c to 113c in FIG. 1) located at the end on the output side (farthest from the input ports 151 to 153) have no adjacent optical switches on the output side, and thus one outputs of these optical switches are not connected to any optical switches.

On the other hand, the other outputs of the optical switches 111a to 111c, 112a to 112c, and 113a to 113c, which serve as outputs of the optical switches 121 to 123, are connected to respective inputs of the optical couplers 131a to 131b, 132a to 132b, and 133a to 133b disposed in the optical couplers 141 to 143. The outputs of the optical couplers 131a to 133a are connected to inputs of the adjacent optical couplers 131b to 133b, respectively, and the outputs of the optical couplers 131b to 133b, which serve as outputs of the optical couplers 141 to 143, are connected to the output ports 161 to 163, respectively.

The multicast switch 10 according to the conventional technique having such a configuration has a function of outputting an optical signal input from an input port from any output port. In addition, in a case where signal wavelengths input from different input ports are different, it is also possible to perform wavelength division multiplexing and output optical signals input from the different input ports without interference of the optical signals.

In general, it is difficult to determine whether an optical switch is operating normally, that is, it is difficult to detect a failure, not just in a multicast switch. Therefore, it is common to detect a failure by providing a circuit for branching and outputting a part of an optical signal outside the optical switch and observing a part of an input optical signal and an output optical signal. A target of the observation may be, for example, the presence or absence of a signal, the optical level of a signal, the wavelength of a signal, or the like. The observation of these leads to acquisition of information such as the presence or absence of an optical signal that should be present, a change in the optical level of a signal that should be generated, and the presence or absence of an optical signal of a wavelength that should be present, and whether the operation of the optical switch is normal is determined on the basis of the acquired information.

However, in a case where such a circuit for branching and outputting a part of an optical signal is provided, there is a problem that a part of an optical signal used for communication is lost by branching, the optical signal level is lowered, and the quality of the optical signal is lowered.

### CITATION LIST

### Non Patent Literature

Non Patent Literature 1: T. Watanabe, K. Suzuki and T. Takahashi, “Silica-based PLC transponder aggregators for colorless, directionless, and contentionless ROADM”, Optical Fiber Communication Conference (OFC), Paper OTh3D.1 (2012).

### SUMMARY OF INVENTION

The present disclosure has been made in view of the above problem, and an object of the present disclosure is to provide an optical switch having a function of a multicast switch or a tree-type optical switch, which corresponds to a multicast switch including one input port, the optical switch being capable of detecting a failure by further including an output port of a monitoring optical signal for determining whether the optical switch is operating normally, and preventing an excessive optical loss from occurring in an optical signal used for optical signal communication.

In order to solve the above problem, the present disclosure provides an optical switch including: at least one switch function unit in which a plurality of one-input/two-output optical switches is connected in cascade; an optical coupler function unit in which a plurality of two-input/one-output optical couplers to which an optical signal output from the switch function unit is input is connected in cascade; and at least one of a first monitoring output port and a second monitoring output port, wherein the first monitoring output port is a port that transmits a first monitoring optical signal output from the switch function unit to an outside, and the second monitoring output port is a port that transmits, to an outside, a second monitoring optical signal output from a two-input/two-output optical coupler provided in place of a two-input/one-output optical coupler located at an end on an output side among the plurality of two-input/one-output optical couplers.

### BRIEF DESCRIPTION OF DRAWINGS

FIG. 1 is a diagram conceptually illustrating a configuration of the multicast switch 10 according to the conventional technique.

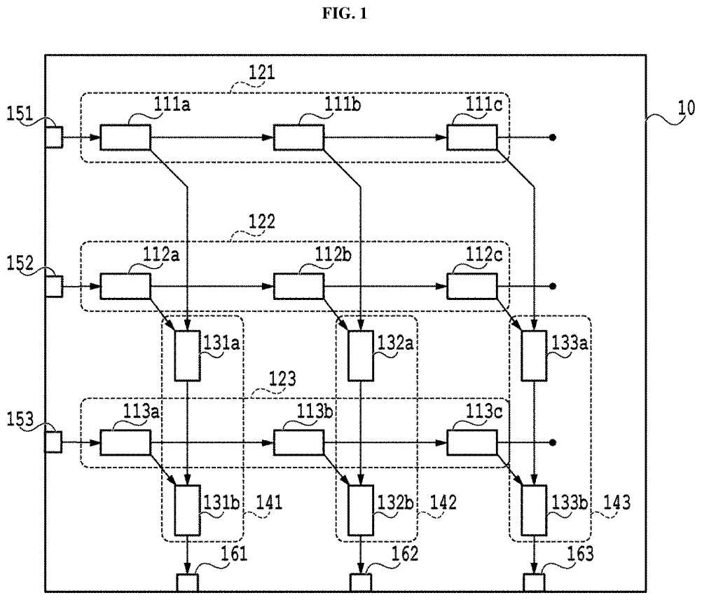

FIG. 2 is a diagram conceptually illustrating a configuration of an optical switch 20 according to the present disclosure.

FIG. 3 is a diagram conceptually illustrating a configuration of an optical switch 30 according to the present disclosure.

FIG. 4 is a diagram conceptually illustrating a configuration of an optical switch 40 according to the present disclosure.

### DESCRIPTION OF EMBODIMENTS

Various embodiments of the present disclosure are described in detail below with reference to the drawings. The same or similar reference signs denote the same or similar components, and redundant description is omitted in some cases. The materials and numerical values are for illustrative purposes and are not intended to limit the scope of the present disclosure. The following description is an example, and some configurations may be omitted, modified, or implemented together with additional configurations without departing from the gist of an embodiment of the present disclosure.

An embodiment of the present disclosure is described in detail below with reference to the drawings. An optical switch according to the present embodiment is a multicast switch including N input ports and M output ports (here, M and N are integers of 2 or more), and relates to a mode further including first and/or second output ports from which a monitoring optical signal for determining whether the optical switch is operating normally is output.

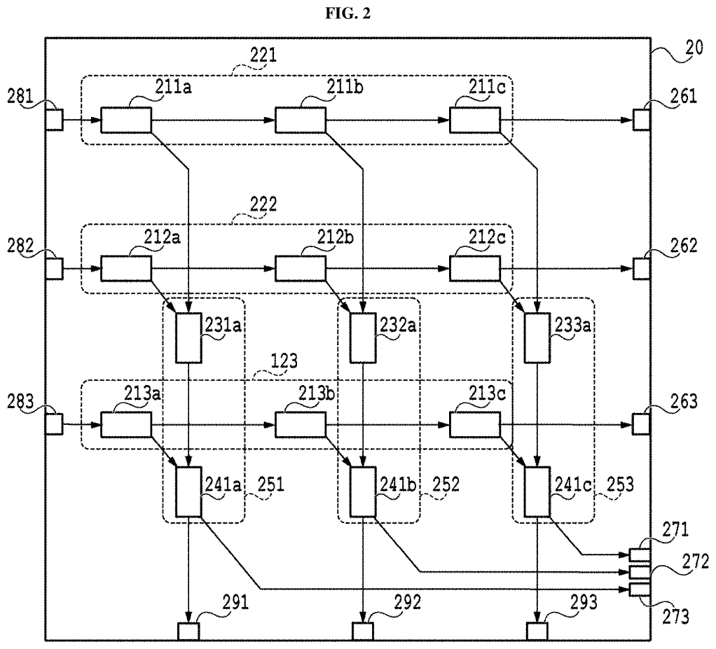

FIG. 2 is a diagram conceptually illustrating a configuration of the optical switch 20 according to the present disclosure. In FIG. 2, as an example, M=3 and N=3 are set, and a form of three inputs and three outputs is illustrated, but the number of M and N is not limited thereto.

As illustrated in FIG. 2, the optical switch 20 includes switch function units 221 to 223 in each of which three (=M) one-input/two-output optical switches 211a to 211c, 212a to 212c, or 213a to 213c are connected in cascade, optical coupler function units 251 to 253 in each of which one (=N-2) of two-input/one-output optical couplers 231a to 231c and one of two-input/two-output optical couplers 241a to 241c connected to respective outputs of the optical couplers 231a to 231c are connected in cascade, first monitoring output ports 261 to 263 that are connected to respective outputs of the optical switches 211c to 213c and each of which is a port for transmitting a monitoring optical signal to the outside, second monitoring output ports 271 to 273 that are connected to respective outputs of the optical couplers 241a to 241c and each of which is a port for transmitting a monitoring optical signal to the outside, input ports 281 to 283 of an optical signal, and output ports 291 to 293 of an optical signal.

In the switch function units 221 to 223, one of the outputs of each of the optical switches 211a to 211b, 212a to 212b, and 213a to 213b is connected to the input of an adjacent optical switch on the output side (for example, one of the outputs of 211a is connected to the input of 211b). However, ones of the outputs of the optical switches (corresponding to the optical switches 211c to 213c in FIG. 2) located at the end on the output side, in other words, farthest from the input ports 281 to 283 are connected to the first monitoring output ports 261 to 263. On the other hand, the other outputs of the optical switches 211a to 211c, 212a to 212c, and 213a to 213c, which serve as outputs of the switch function units 221 to 223, are connected to respective inputs of the optical couplers 231a to 231c in the optical coupler function units 251 to 253.

In the optical coupler function units 251 to 253, the outputs of the optical couplers 231a to 231c are connected to respective inputs of the optical couplers 241a to 241c. Of the respective outputs of the optical couplers 241a to 241c, one outputs are connected to the output ports 291 to 293 as in the conventional technique, but the other outputs are connected to the second monitoring output ports 271 to 273.

In the optical switch 20 according to the present embodiment having such a configuration, it is assumed that an optical signal is input from an input port (for example, the input port 282), and any optical switch of the switch function units 221 to 223 (for example, the optical switch 212b) is connected to the output port (for example, the output port 292) side. At this time, the optical signal passing through the optical switch 212b is guided to the output port 292 via the optical coupler function unit 252, and thus the optical signal is not output from the first monitoring output port 262. Therefore, if the first monitoring output port 262 is monitored under such conditions and an optical signal is observed, it is possible to detect that the optical switch 212b has failed.

Furthermore, in the optical switch 20, for example, in a case where an optical signal is input from the input port 282 and the optical switch 212b is connected to the output port 292 side, the optical signal is output even from the second monitoring output port connected to the optical coupler 241b. Therefore, if the optical signal output from the second monitoring output port is monitored and the optical signal is not observed, it is possible to detect that the optical switch 212b has failed.

Note that the optical switch 20 can be manufactured by a silica-based planar lightwave circuit technique, which forms an optical switch on a Si substrate, and can be expected to achieve good optical characteristics. In this case, the optical switch 20 is a waveguide type optical switch, and may be driven by use of a thermo-optical effect.

In addition, a configuration may be employed in which photoelectric conversion elements (for example, p-n junction photodiodes) are installed in the first monitoring output ports 261 to 263 and the second monitoring output ports 271 to 273, so that an output of an electric signal can be acquired, and the presence or absence of an optical signal, the level of the optical signal, and the like may be obtained from the electric signal.

As described above, in the optical switch 20 according to the present embodiment, since the connection function between the input ports 281 to 283 and the output ports 291 to 293 is the very function provided by the multicast switch according to the conventional technique, the conventional function as an optical switch is maintained. Furthermore, the first monitoring output ports 261 to 263 and the second monitoring output ports 271 to 273 are separately installed and optical signals output therefrom are monitored, so that an effect of enabling detection of a failure of the optical switch is obtained. In addition, the optical switch 20 according to the present embodiment is not configured to branch a part of an optical signal, unlike the conventional technique, and thus, it is possible to suppress an excessive loss of the optical signal due to detection of a failure.

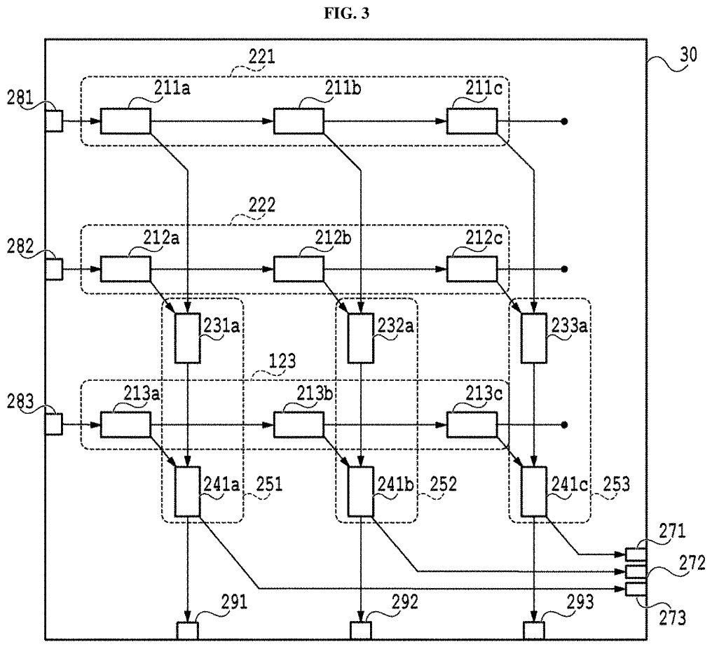

Note that, although a mode including both the first monitoring output ports 261 to 263 and the second monitoring output ports 271 to 273 has been described in the present embodiment, an optical switch according to the present disclosure has a similar effect even in a mode including only the second monitoring output ports 271 to 273 as in the optical switch 30 illustrated in FIG. 3.

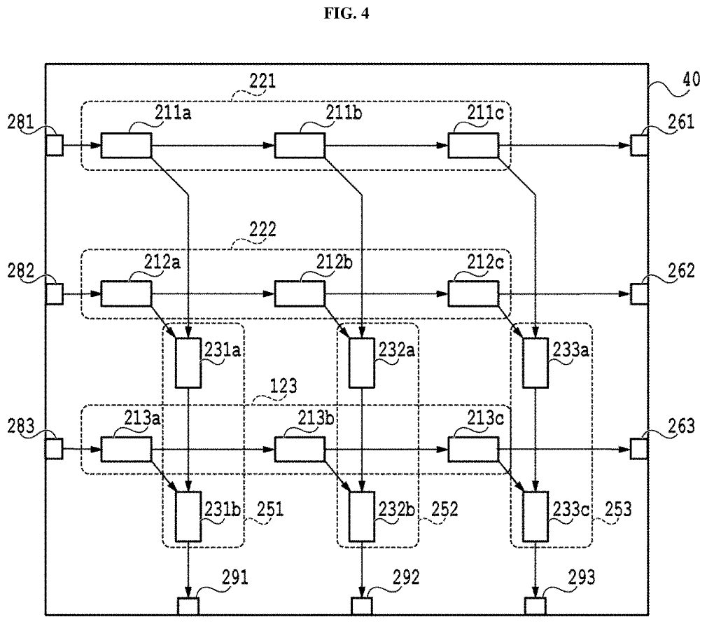

In addition, a similar effect is obtained even in a mode including only the first monitoring output ports 261 to 263 as in the optical switch 40 illustrated in FIG. 4. In this case, N-1 two-input/one-output optical couplers 231b to 233b are installed as optical couplers at the end (closest to the output side) in the optical coupler function units 251 to 253. As a result, it is also possible to set N=1, and the case of N=1 corresponds to a tree type switch of one-input/M-output.

### INDUSTRIAL APPLICABILITY

As described above, the optical switch according to the present disclosure includes a mechanism for determining whether the optical switch is normally operating without causing an excessive optical loss of an optical signal. Therefore, the optical switch is expected to be applied to an optical communication network as a highly efficient optical switch.

1. An optical switch comprising:
at least one switch function unit wherein a plurality of one-input/two-output optical switches is connected in cascade;
an optical coupler function unit wherein a plurality of two-input/one-output optical couplers that an optical signal output from the switch function unit is input is connected in cascade; and
at least one of a first monitoring output port and a second monitoring output port, wherein
the first monitoring output port is a port that transmits a first monitoring optical signal output from the switch function unit to an outside, and
the second monitoring output port is a port that transmits, to an outside, a second monitoring optical signal output from a two-input/two-output optical coupler provided in place of a two-input/one-output optical coupler located at an end on an output side among the plurality of two-input/one-output optical couplers.

2. The optical switch according to claim 1, further comprising a photoelectric conversion element that converts an optical signal transmitted from at least one of the first monitoring output port and the second monitoring output port into an electric signal.

3. The optical switch according to claim 1, wherein:
the optical switch is a waveguide type optical switch formed on a silicon substrate, including silica-based glass containing SiO₂ as a main component, and manufactured by a planar lightwave circuit technique; and
the optical switch is driven by use of a thermo-optical effect.
